(19) United States
(12) Patent Application Publication
(10) Pub. No.: US 2010/0212245 A1
(43) Pub. Date: Aug. 26, 2010

(54) Fastening Plate for Grooved Decking Boards

(76) Inventor: Glenn J. Tebo, Kingston, NH (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 12/708,885

(22) Filed: Feb. 19, 2010

Related U.S. Application Data
(60) Provisional application No. 61/154,295, filed on Feb. 20, 2009.

(51) Int. Cl. E04B 5/00; E04F 15/14; B25C 1/00

(52) U.S. Cl. 52/393; 52/582.1; 227/135

(57) ABSTRACT

A fastening member and a magazine configured to deliver each of a plurality of the fastening members into a groove in a decking member. The fastening member includes a generally planar first surface, a generally planar second surface generally parallel to the first surface and at least one side generally perpendicular to the first surface and the second surface and circumscribing at least a portion of the first surface and the second surface, wherein the fastening member is configured to be positioned at least partially in a groove in a first decking member and the fastening member is configured to provide a nominal spacing between the first decking member and the adjacent decking member; and an expansion feature configured to accommodate expansion of an adjacent decking member adjacent the first decking member.

### CROSS-REFERENCE TO RELATED APPLICATIONS

This application claims the benefit of U.S. provisional patent application Ser. No. 61/154,295, filed Feb. 20, 2009, the entire disclosure of which is incorporated herein by reference.

### FIELD

The present invention relates in general to fastening plates, and, more particularly, to a fastening plate and a means of delivering the fastening plate.

### BACKGROUND

A wide variety of fastener configurations for securing structural members to other members are known. In one example, a deck fastener may be used for securing decking members to associated joists in the construction of an exterior deck, or the like. It is desirable that deck fasteners be configured for securing decking members to associated joists without a fastener head protruding from a deck surface. It is also desirable to position a decking member relative to an adjacent decking member to allow for and/or accommodate expansion and/or contraction of the decking member(s) due to, for example, variations in environmental conditions, e.g., temperature and/or humidity. Fastening members may be positioned in grooves in decking members and the fastening members may be fixed (i.e., fastened) to an associated joist using a fastener thereby securing the fastening member and decking members to the associated joist.

Fastening members, e.g., “biscuits”, are generally manually positioned in a groove in a first decking member, fastened in place and an adjacent decking member may then be positioned such that the biscuit extends into a corresponding groove in the adjacent decking member. Spacing between the decking member and the adjacent decking member is generally established by a feature, e.g., one or more spacers, extending from a surface of the biscuit. The spacer(s) are generally configured to contact an edge of each decking member. To achieve improved efficiency in positioning fastening members, there is a need for an improved system and method for positioning fastening members while allowing for expansion and contraction of the decking member(s).

### BRIEF DESCRIPTION OF THE DRAWINGS

For a better understanding of the present invention, together with other objects, features and advantages, reference should be made to the following detailed description which should be read in conjunction with the accompanying figures, wherein:

FIG. 1A is a top view of one exemplary embodiment of a magazine for guiding a plurality of fastening members consistent with the present disclosure;

FIG. 1B is a side view of the system of FIG. 1A;

FIG. 2A is top, sectional view of one exemplary embodiment of a fastening member, in position in grooves of a decking member and an adjacent decking member;

FIG. 2B is a side sectional view of the exemplary fastening member of FIG. 2A;

FIGS. 3A through 3L are schematic illustrations of a variety of fastening members consistent with the present disclosure;

FIGS. 4A through 4C are schematic illustrations of exemplary collating features for fastening members consistent with the present disclosure;

FIGS. 5A through 5C are schematic illustrations of tools coupled to magazine(s) for fastening members in a system for positioning fastening members and driving fasteners consistent with the present disclosure; and

FIG. 6 is a schematic illustration including a tool, magazine and fastening member after driving a fastener into a decking member and a joist.

### DETAILED DESCRIPTION

For ease of explanation, systems consistent with the present disclosure may be shown and described herein in connection a nail-type fastener. It will be recognized, however, a system and method consistent with the present disclosure will be useful in connection with a wide variety of fastener configurations. In addition, exemplary embodiments may be described herein in connection with fastening decking members to associated joists. It is to be understood, however, that a system and method consistent with the present disclosure may be useful in connection with fasteners and/or fastening members configured for use with any type of material including wood, composite materials, concrete, metal, plastic, textiles and other materials. The exemplary embodiments described herein are thus provided only by way of illustration, and are not intended to be limiting.

Generally, the present disclosure relates to fastening members, e.g., fastening plates, configured for fastening decking members to joists. The fastening members are configured to allow expansion and/or contraction of the decking members and to facilitate spacing between two adjacent decking members. For example, a fastening member may define an opening configured to collapse when the decking member(s) expand. In another example, a fastening member may include a portion configured to penetrate a decking member as the decking member expands thereby accommodating expansion of the decking member.

The fastening members may be further configured for collating and/or loose delivery to the decking member(s) via a magazine. The magazine may include and/or may be coupled to a guide member configured to facilitate positioning the magazine and the fastening member relative to the first decking member, e.g., in a groove configured to receive the fastening member. The magazine may be configured to attach to a tool configured to drive a fastener into the fastening member and into an associated joist. The fastener may or may not pass through the first decking member. For example, the tool may be power nailer (e.g., pneumatic, internal combustion and/or electric), a power stapler (e.g., pneumatic and/or electric) or another fastener system, e.g., screw fastener system, and may include a magazine of fasteners.

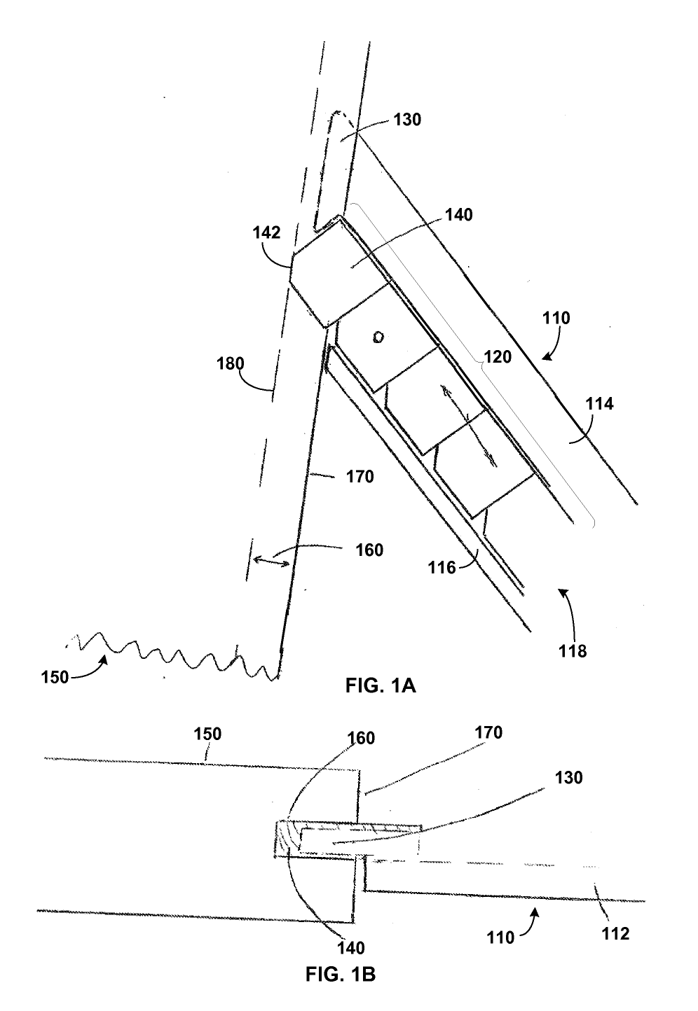

Turning to FIGS. 1A and 1B, there is illustrated one exemplary embodiment of a system for positioning and/or guiding a plurality of fastening members consistent with the present disclosure. The system includes a magazine 110 configured to hold a plurality 120 of fastening members. The magazine 110 may include a base member 112 and first 114 and second 116 rails on opposed sided of the base member 112. The rails 114, 116 may define a channel 118 for slidably receiving a fastening member 140. The magazine 110 may include a guide member 130 configured to facilitate positioning the magazine 110 and/or a fastening member 140 relative to a first decking member 150. The guide member 130 may be coupled to the base member 112 of the magazine 110 and may be aligned with at least one rail 114, 116. The plurality 120 of fastening members in the magazine 110 may be biased toward the guide member 130. For example, a spring may bias the plurality 120 of fastening members toward the guide member 130. The guide member 130 may be configured to maintain the plurality 120 of fastening members in the magazine 110.

The first decking member 150 may include an edge 170 and may define a groove 160 in the edge 170. The groove 160 may be configured to receive at least a portion of the fastening member 140. The guide member 130 may be configured to extend at least partially into the groove 160. At least a portion of the fastening member 140 may extend beyond the guide member 130. For example, a side 142 of the fastening member may be configured to contact the first decking member 150 at a base 180 of the groove 160.

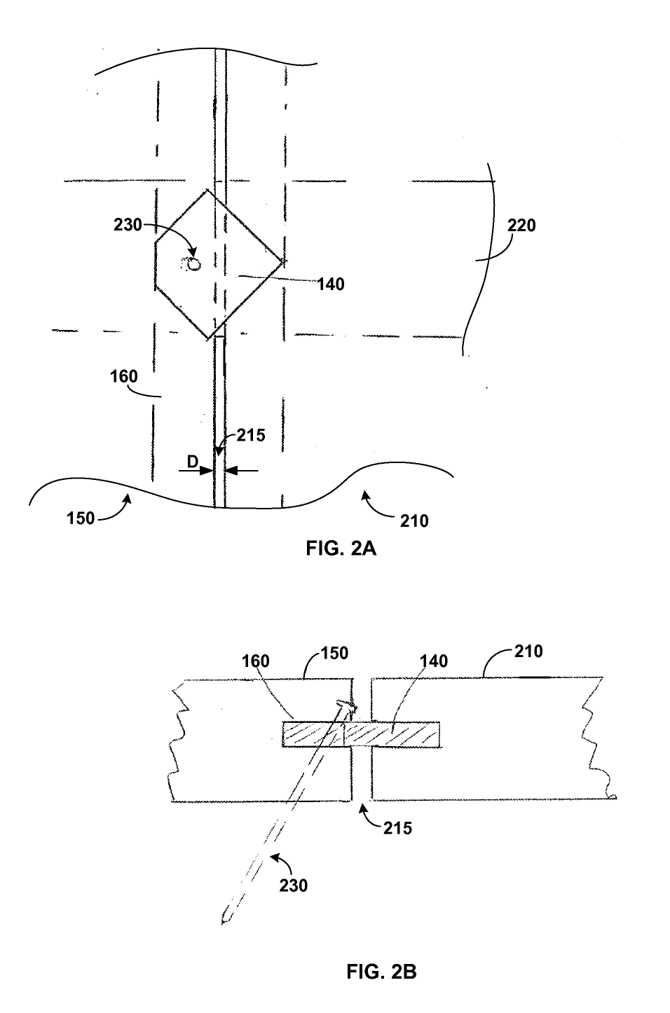

Turning to FIGS. 2A and 2B, there is illustrated two views of the first decking member 150 and an adjacent decking member 210. The first decking member 150 and adjacent decking member 210 may be fastened to an associated joist 220 by, e.g., a fastener 230 and/or fastening member 140. The adjacent decking member 210 may be positioned a distance, D, from decking member 150, providing a gap 215 between decking member 150 and adjacent decking member 210. The gap 215 is configured to allow expansion of decking member(s). The gap 215 may also allow liquids, e.g., water, to run off the decking member(s). The distance D may vary based on the relative expansion and/or contraction of decking member 150 and/or adjacent decking member 210. The fastening member 140 may be configured to facilitate expansion and/or contraction of decking member 150 and/or adjacent decking member 210, as described herein. The fastening member 140 may be configured to provide a nominal spacing between decking member 150 and adjacent decking member 210. For example, the fastening member 140 may be sized according to a depth of groove 160 and a desired nominal spacing between decking member 150 and adjacent decking member 210.

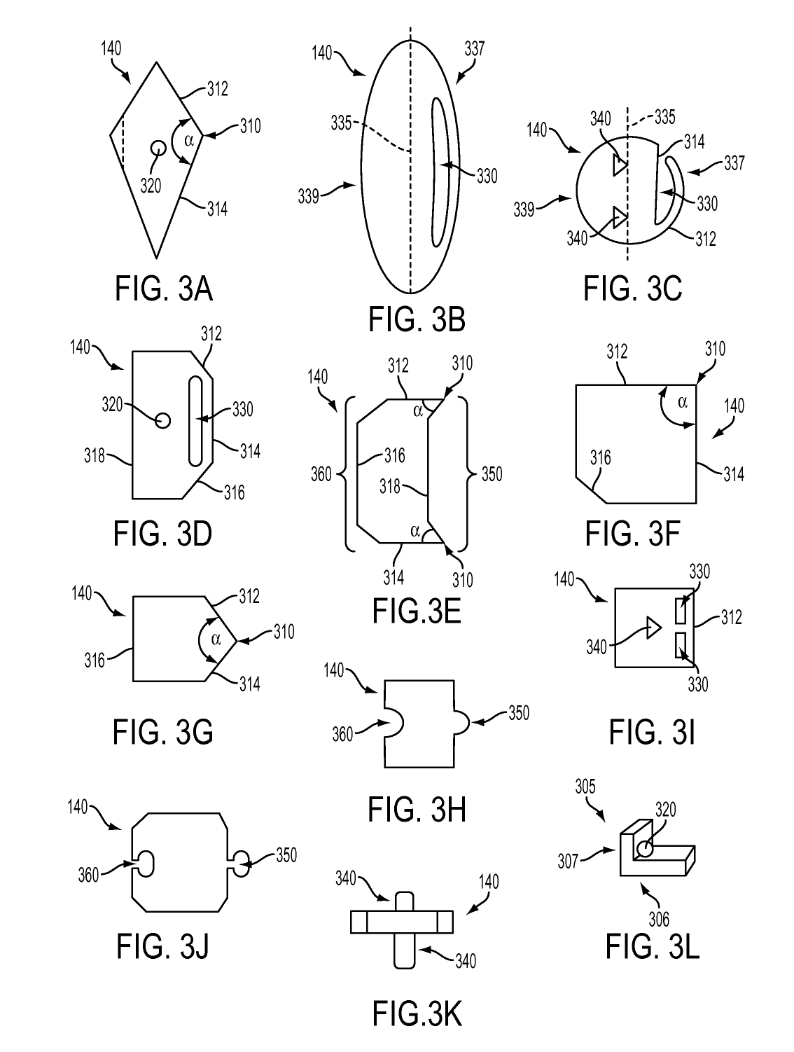

Turning to FIGS. 3A through 3L, there is illustrated various exemplary fastening member configurations. Each fastening member 140 may generally include a first surface, an opposing second surface and at least one side circumscribing at least a portion of the first and second surfaces. The first surface and the second surface may be generally planar and the first planar surface may be generally parallel the second planar surface. The side(s) may be generally perpendicular to the first surface and the second surface. For a fastening member that has been installed, i.e., that has been fastened to a decking member, e.g., decking member 150, as described herein, the first surface may correspond to a top surface and the second surface may correspond to a bottom surface. FIGS. 3A through 3J are top (or bottom) views, FIG. 3K is a side view and FIG. 3L is a perspective view.

The first and second surfaces of each fastening member may be generally polygonal, ellipsoidal and/or a combination thereof. A shape, e.g., polygonal, elliptical, etc., of the first and second surfaces may describe a shape of the fastening member. As used herein, a polygonal shaped fastening member may be understood as having polygonal shaped first and second surfaces. Each fastening member may include one or more features for accommodating expansion and/or contraction of decking member(s), one or more features for spacing decking members, and/or one or more features for collating a plurality of fastening members for insertion into and delivery from, e.g., a magazine. In some configurations, a fastening member may define an opening configured to receive a fastener. In other configurations, a fastening member may not define such an opening. In these other configurations, at least a portion of a fastener may be driven through the fastening member by, e.g., a tool, as described herein.

A fastening member may be sized to provide a nominal spacing between a first decking member and an adjacent decking member. For example, the fastening member may contact the base of the groove in the first decking member and the base of the groove in the adjacent decking member to provide the nominal spacing. As described herein, a fastening member may be configured to accommodate expansion of decking member(s). For example, a fastening member may include a penetrating portion configured to contact an adjacent decking member, e.g., at a base of the groove in the adjacent decking member and to penetrate the adjacent decking member as the decking member(s) expand. An amount of penetration may depend on an amount of expansion of the decking member(s).

In another example, the fastening member may define a collapsible opening. The collapsible opening may extend from and through the first surface to and through the second surface. The collapsible opening may be configured to collapse as the decking member(s) expand. In this example, the fastening member may not be configured to penetrate the adjacent decking member. In yet another example, the collapsible opening may be configured as a plurality of openings.

In yet another example, the fastening member may include one or more spacers configured to provide nominal spacing between the first decking member and the adjacent decking member. In this example, the fastening member may or may not contact the base of the groove in the first decking member and/or the adjacent decking member. The spacer(s) may contact the edges of the first decking member and the adjacent decking member. The spacer(s) may be configured to penetrate the adjacent decking member as the decking member(s) expand.

FIG. 3A illustrates an example of a fastening member 140 with a generally polygonal shape. In this example, a fastener opening 320 is defined in fastening member 140 and the fastening member 140 includes four sides 312, 314, 316, 318. A penetrating portion 310 includes an intersection of a first side 312 and a second side 314 and may extend a distance from the intersection along each of the two sides 312, 314. The first side 312 and the second side 314 define an angle, α, at their intersection. A relatively smaller angle, α, may facilitate penetration of the fastening member into the adjacent decking member and therefore expansion of the decking member(s).

FIG. 3B illustrates an example of a fastening member 140 with a generally elliptical shape. In this example, the fastening member 140 may have one side. For illustration purposes, a center line 335 is shown bisecting the one side of the fastening member 140 into a first side portion 337 and a second side portion 339. In this example, a collapsible opening 330 is defined in the fastening member 140. The collapsible opening 330 may be positioned between the center line 335 and the first side portion 337. The second side portion 339 may be configured to contact the base of the groove of the first decking member, as described herein. The first side portion 337 may be configured to contact the adjacent decking member. The collapsible opening 330 may be configured to accommodate expansion of the decking member(s) by collapsing as the decking member(s) expand.

FIG. 3C illustrates an example of a fastening member 140 with a generally circular shape. In this example, fastening member 140 may have a first side 312 and a second side 314. The first side 312 circumscribes at least a portion of an outer circumference of the fastening member 140 and has a first side portion 337 and a second side portion 339. The first side portion 337 and second side portion 339 are delineated by a centerline 335. Fastening member 140 has a collapsible opening 330 positioned between the center line 335 and the first side portion 337 of the first side 312. The second side 314 circumscribes the collapsible opening 330. Fastening member 140 may include at least one spacer 340. The spacer(s) 340 may extend from a first surface and/or a second surface of the fastening member 140. The spacer(s) 340 may be positioned on the first surface and/or second surface between the center line 335 and the second portion 339 of the first side 312. The spacer(s) 340 may be configured to provide a nominal spacing between a decking member and an adjacent decking member. The spacer(s) 340 may be configured to have a penetrating portion to facilitate and/or accommodate expansion of the decking member(s). In this example, the spacer(s) 340 are configured to contact an edge of the first decking member when the fastening member 140 is inserted in the groove. In other words, the spacer(s) 340 may be configured to provide the distance, D, between the first decking member and the adjacent decking member.

FIG. 3D illustrates another example of a fastening member 140 with a generally polygonal shape. In this example, fastening member 140 has six sides and defines a collapsible opening 330 and a fastener opening 320. A first side 312, second side 314 and third side 316 are configured to facilitate collapsing collapsible opening 330 as the decking member(s) expand. The second side 314 may contact the adjacent decking member and a fourth side 318, opposing the second side 314, may contact the first decking member.

FIG. 3E illustrates yet another example of a fastening member 140 with a generally polygonal shape. In this example, fastening member 140 includes two penetrating regions 310, each penetrating region 310 is positioned adjacent an opposing first side 312 and second side 314. A third side 316 is configured to contact the first decking member and the penetrating regions 310 are configured to contact the adjacent decking member. For example, the third side 316 may contact the first decking member 150 at a base of the groove in the first decking member 150 and the penetrating regions 310 may contact the adjacent decking member 210 at a base of the groove in the adjacent decking member 210.

The third side 316 and an opposing fourth side 318 are generally parallel and have generally equal lengths. The third side 316 and fourth side 318 may be generally perpendicular to the first side 312 and the second side 314. The shape of fastening member 140 is configured to facilitate collating a plurality of fastening members. For example, the fourth side 318 of a first fastening member may be positioned adjacent the third side 316 of a second fastening member and the third side 316 of a third fastening member may be positioned adjacent the fourth side 318 of the second fastening member and so on. The collated fastening members may be contained in a magazine, e.g., magazine 110.

FIGS. 3F and 3G illustrate examples of fastening members 140 with a generally polygonal shape. In this example, the fastening member 140 may have five sides. A first 312 and a second 314 side define an angle, α, at their intersection, forming a penetrating portion 310. A third side 316, opposing the intersection of the first 312 and second 314 side, may be configured to contact the base of a groove in the first decking member. The penetrating portion 310 may be configured to contact and/or penetrate the adjacent decking member, as described herein.

FIG. 3I illustrates yet another example of a fastening member 140. In this example, the fastening member 140 is generally polygonal and has four sides, i.e., generally square. The fastening member 140 defines a plurality of collapsible openings 330 adjacent a first side 312. In this example, the fastening member 140 includes a spacer 340 positioned generally near a center of a surface of the fastening member 140. As shown in FIG. 3K, the spacer 340 may be positioned on a first (e.g., top) surface and/or on a second (e.g., bottom) surface.

FIGS. 3H and 3J illustrate two examples of a fastening member 140 that include collating features 350 and 360. A first collating feature 350 may be positioned on a first side opposing a second side containing a second collating feature 360. The first collating feature 350 is configured as a complement to the second collating feature 360. In other words, the first collating feature 350 may have a shape generally similar to a shape of the second collating feature 360. The collating features 350, 360 may be configured to “fit together” similar to, e.g., puzzle pieces. The exemplary fastening member illustrated in FIG. 3E is similarly configured with collating features 350, 360.

FIG. 3L illustrates an example of a half-plate fastening member 305. The half-plate fastening member 305 is configured to contact an edge of the first decking member. The half-plate fastening member 305 may be used, for example, for decking members that include a groove on one side. The half-plate fastening member 305 includes a groove portion 306 and a spacer portion 307. The spacer portion 307 may be generally perpendicular to the groove portion 306. The groove portion 306 is configured for positioning in a groove of the first decking member or the adjacent decking member. The spacer portion 306 is configured to contact an edge of the first decking member and an edge of the adjacent decking member. The spacer portion may define a fastener opening 320.

It will be appreciated by one skilled in the art that FIGS. 3A through 3L illustrate only some of the possible configurations of fastening members. Other configurations are possible within the scope of the present disclosure. It will be further appreciated that combinations of features may also be implemented, within the scope of the present disclosure. Accordingly, the exemplary embodiments shown in FIGS. 3A through 3L, provided by way of illustration, are not intended to be limiting.

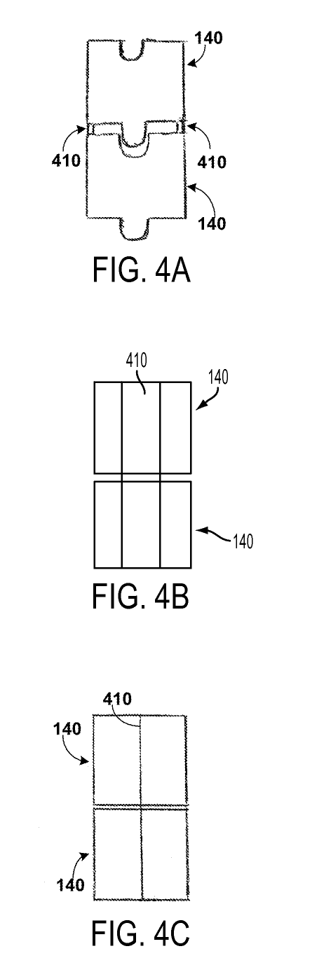

Turning to FIGS. 4A through 4C, there is illustrated a variety of techniques for collating a plurality of fastening members. Collating may include one or more couplings 410 between adjacent fastening members 140. For example, as shown in FIG. 4A, adjacent fastening members 140 may be welded to each other. In this example, one or more welds 410 may couple the adjacent fastening members 140. In another example, coupling 410 may result from manufacturing a plurality of fastening members 140. In this example, the plurality of fastening members may be stamped and the coupling(s) 410 may remain after the stamping process.

FIG. 4B illustrates coupling using, e.g., an adhesive tape. FIG. 4C illustrates coupling using, e.g., a wire. In both examples, the coupling 410 is configured to couple adjacent fastening members to each other, providing a plurality of collated, coupled fastening members. In another example, adjacent fastening members 140 may be attached to each other using an adhesive. In yet another example, adjacent fastening members may be coupled to each other using a coating material, e.g., plastic.

The couplings and/or coupling material are configured to collate the fastening members to facilitate delivery using a magazine, e.g., magazine 110. The couplings and/or coupling material are configured to break during fastening and/or to be broken after fastening the fastening member to the decking member(s) and/or joist, e.g., joist 220, as described herein.

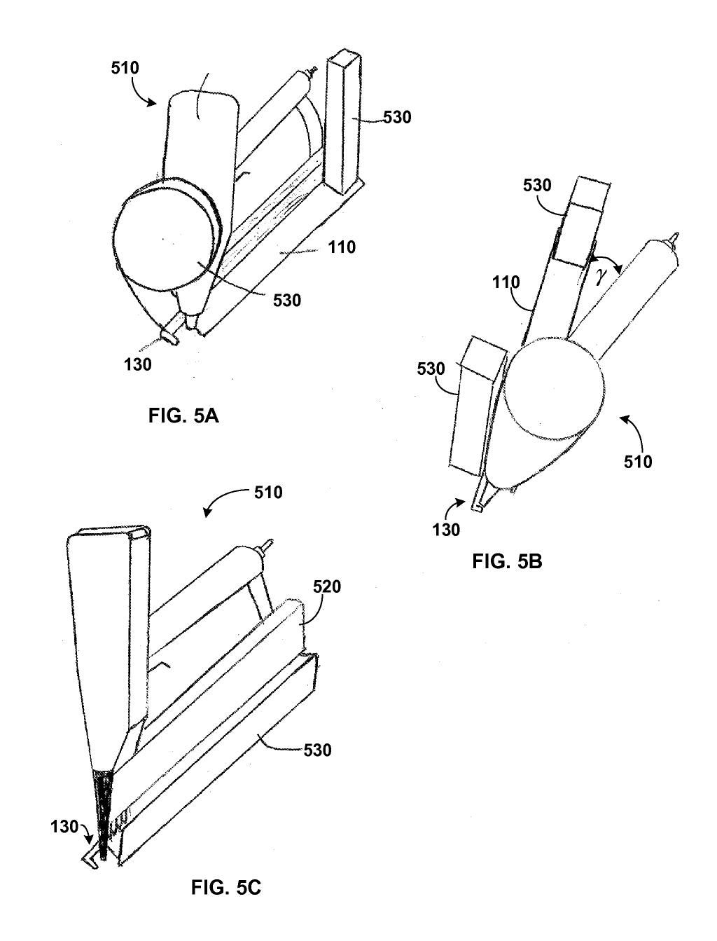

Turning to FIGS. 5A through 5C, there is illustrated examples of tools 510, e.g., power nailers, power staplers and/or screw systems, as described herein, and one or more magazines, coupled to a tool 510. A fastener magazine 520, configured to receive, hold and/or deliver to the tool, a plurality of fasteners, as understood by one skilled in the art, may be coupled to the tool 510. A fastening member magazine 110, configured to receive, hold and/or deliver a plurality 120 of fastening members may be coupled to the tool 510. The fastening member magazine 110 may be coupled to tool 510 at an angle, y, with respect to the tool 510. The angle may be adjustable, facilitating positioning the magazine for ease of installation of fasteners and/or fastening members. A guide member 130, as described herein, may be integral with or coupled to the fastening member magazine 110.

A secondary supply 530 of fastening members 140 may be coupled to the tool 510 and/or the fastening member magazine 110. The secondary supply 530 is configured to supply a relatively larger number of fastening members 140 than may be contained in the fastening member magazine 110. For example, the secondary supply 530 may be configured as a coil of collated coupled fastening members. In another example, the secondary supply 530 may be configured as a stack of collated loose fastening members. In this example, the stack may be coupled to the magazine 110, away from the tool 510 and/or may be coupled to the tool 510.

The secondary supply 530 of fastening members 140 may be configured to bias at least one fastening member 140 for delivery to the fastening member magazine 110 and/or a decking member. Bias and/or delivery may be provided by pneumatic, electrical, mechanical and/or other means known to one skilled in the art. Bias and/or delivery may be manual and/or may be automatic.

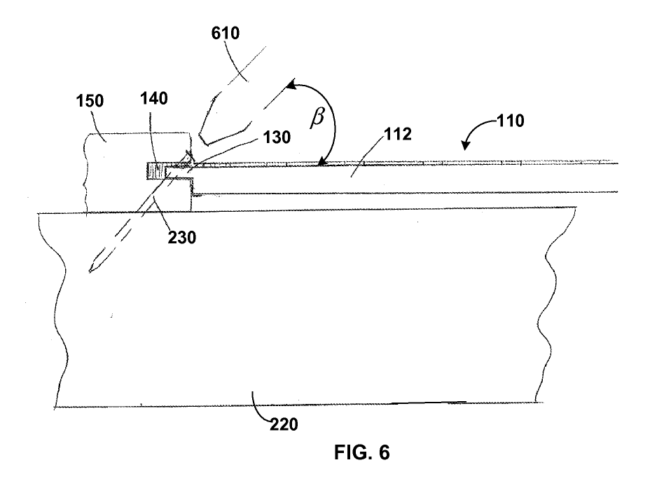

Turning to FIG. 6, there is illustrated a tool nose 610 and fastening member magazine 110, after driving a fastener 230 through a decking member 150 into a joist 220. In this illustration, the guide member 130 has not yet been removed from the groove 160. The tool nose 610 may be positioned and/or aligned by the guide member 130. For example, the tool nose 610 may be positioned relative to the first decking member 150 to allow delivery of a fastener into the first decking member, i.e., to allow depression of a safety lever so that the tool will drive a fastener, as is known in the art. The tool nose 610 may be aligned to drive the fastener 230 into the joist 220, at an angle, β, relative to the joist 220. The angle, β, may be adjustable and may be in the range of about 30 degrees to about 90 degrees.

For example, in operation, the magazine 110 may be positioned such that the guide member 130 and at least a portion of fastening member 140 are positioned in the groove 160. At least a portion of an edge of fastening member 140 may then contact the base 180 of groove 160. A fastener 230 may then be driven through fastening member 140 into an associated joist 220 by a tool. The fastener 230 may or may not pass through the first decking member 150. The fastener 230 may then couple the fastening member 140, the first decking member 150 and the associated joist 220. The magazine 110 may then be removed, leaving the fastening member 140 coupled to the first decking member 150 and associated joist 220. A next fastening member in the plurality 120 of fastening members may then be positioned in the magazine 110, extending beyond the guide member 130, ready for insertion in another location in groove 160 in the first decking member and/or in another decking member.

Accordingly, a fastening member, as described herein, may include features for collating a plurality of fastening members for delivery using, e.g., a magazine. The fastening member may include features for spacing a first decking member and an adjacent decking member and/or for accommodating expansion and/or contraction of the decking member(s). A magazine and/or secondary source of fastening members, as described herein, are configured to provide a plurality of fastening members to a tool for installation. A guide member, as described herein, is configured to position the magazine and/or fastening member, and therefore the tool, relative to a decking member for ease of installation of a fastener and fastening member.

According to one aspect, there is disclosed a fastening member. The fastening member may include a generally planar first surface, a generally planar second surface generally parallel to the first surface and at least one side generally perpendicular to the first surface and the second surface and circumscribing at least a portion of the first surface and the second surface, wherein the fastening member is configured to be positioned at least partially in a groove in a first decking member and the fastening member is configured to provide a nominal spacing between the first decking member and the adjacent decking member. The fastening member may include an expansion feature configured to accommodate expansion of an adjacent decking member adjacent the first decking member; a collating feature configured for collating a plurality of the fastening members to facilitate delivery of the plurality of the fastening members to the first decking member, a fastener opening defined by the fastening member, the fastener opening configured to receive a fastener, and a spacing member configured to provide the nominal spacing between the first decking member and the adjacent decking member, wherein the spacing member is positioned on at least one of the first surface and the second surface.

According to another aspect, there is provided a fastening member. The fastening member may include a generally planar first surface, a generally planar second surface generally parallel to the first surface and at least one side generally perpendicular to the first surface and the second surface and circumscribing at least a portion of the first surface and the second surface, wherein the fastening member is configured to be positioned at least partially in a groove in a first decking member and the fastening member is configured to provide a nominal spacing between the first decking member and the adjacent decking member; and an expansion feature configured to accommodate expansion of an adjacent decking member adjacent the first decking member.

According to another aspect, there is provided an apparatus that may include a magazine configured to receive and hold a plurality of fastening members and to deliver each of the plurality of fastening members into a groove in a decking member; and a guide member coupled to the magazine, the guide member configured to guide the magazine to position the magazine relative to the groove in the decking member for delivery of at least one of the plurality of the fastening members at least partially into the groove in the decking member.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible.

What is claimed is:

1. A fastening member comprising:
a generally planar first surface, a generally planar second surface generally parallel to the first surface and at least one side generally perpendicular to the first surface and the second surface and circumscribing at least a portion of the first surface and the second surface, wherein said fastening member is configured to be positioned at least partially in a groove in a first decking member and said fastening member is configured to provide a nominal spacing between said first decking member and said adjacent decking member; and
an expansion feature configured to accommodate expansion of an adjacent decking member adjacent said first decking member.

2. A fastening member according to claim 1, further comprising a collating feature configured for collating a plurality of said fastening members to facilitate delivery of said plurality of said fastening members to said first decking member.

3. A fastening member according to claim 1, further comprising a spacing member configured to provide said nominal spacing between said first decking member and said adjacent decking member, wherein said spacing member is positioned on at least one of said first surface and said second surface.

4. A fastening member according to claim 1, wherein said expansion feature comprises a penetrating region configured to penetrate said adjacent decking member when at least one of said first decking member and said adjacent decking member expand, said penetrating feature comprising an intersection of a first side and a second side wherein said intersection defines an angle of said penetrating region.

5. A fastening member according to claim 1, wherein said expansion feature comprises a collapsible opening defined in said fastening member, said collapsible opening extending from said first surface through said fastening member to and through said second surface.

6. A fastening member according to claim 3, wherein said spacing member is configured to penetrate said adjacent decking member to accommodate expansion of at least one of said first decking member and said adjacent decking member.

7. A fastening member according to claim 1, further comprising a fastener opening defined by said fastening member, said fastener opening configured to receive a fastener.

8. A fastening member according to claim 1, further comprising:
a collating feature configured for collating a plurality of said fastening members to facilitate delivery of said plurality of said fastening members to said first decking member,
a fastener opening defined by said fastening member, said fastener opening configured to receive a fastener, and
a spacing member configured to provide said nominal spacing between said first decking member and said adjacent decking member, wherein said spacing member is positioned on at least one of said first surface and said second surface.

9. A fastening member comprising:
a generally planar first surface, a generally planar second surface generally parallel to the first surface and at least one side generally perpendicular to the first surface and the second surface and circumscribing at least a portion of the first surface and the second surface, wherein said fastening member is configured to be positioned at least partially in a groove in a first decking member and said fastening member is configured to provide a nominal spacing between said first decking member and said adjacent decking member;
an expansion feature configured to accommodate expansion of an adjacent decking member adjacent said first decking member;
a collating feature configured for collating a plurality of said fastening members to facilitate delivery of said plurality of said fastening members to said first decking member,
a fastener opening defined by said fastening member, said fastener opening configured to receive a fastener, and
a spacing member configured to provide said nominal spacing between said first decking member and said adjacent decking member, wherein said spacing member is positioned on at least one of said first surface and said second surface.

10. An apparatus comprising:
a magazine configured to receive and hold a plurality of fastening members and to deliver each of said plurality of fastening members into a groove in a decking member; and
a guide member coupled to said magazine, said guide member configured to guide said magazine to position said magazine relative to said groove in said decking member for delivery of at least one of said plurality of said fastening members at least partially into said groove in said decking member.

11. An apparatus according to claim 10, wherein said plurality of fastening members is collated.

12. An apparatus according to claim 10, further comprising a secondary source of fastening members coupled to said magazine, wherein said secondary source is configured to provide additional fastening members to said magazine.

13. An apparatus according to claim 12, wherein said secondary source of fastening members is a coil of collated fastening members.

14. An apparatus according to claim 12, wherein said secondary source of fastening members is a stack of loose fastening members.

15. An apparatus according to claim 10, wherein said magazine is coupled to a tool configured drive a fastener through each of said plurality of fastening members wherein said magazine is coupled to said tool at an angle relative to said tool.

16. An apparatus according to claim 10, wherein each of said plurality of fastening members comprises:
a generally planar first surface, a generally planar second surface generally parallel to the first surface and at least one side generally perpendicular to the first surface and the second surface and circumscribing at least a portion of the first surface and the second surface, wherein said fastening member is configured to be positioned at least partially in a groove in a first decking member and said fastening member is configured to provide a nominal spacing between said first decking member and said adjacent decking member; and
an expansion feature configured to accommodate expansion of an adjacent decking member adjacent said first decking member.

17. An apparatus according to claim 16, wherein each of said plurality of fastening members further comprises a collating feature configured for collating a plurality of said fastening members to facilitate delivery of said plurality of said fastening members to said first decking member.

18. An apparatus according to claim 10, wherein each of said plurality of fastening members further comprises a spacing member configured to provide said nominal spacing between said first decking member and said adjacent decking member, wherein said spacing member is positioned on at least one of said first surface and said second surface.

19. An apparatus according to claim 10, wherein said expansion feature comprises a penetrating region configured to penetrate said adjacent decking member when at least one of said first decking member and said adjacent decking member expand, said penetrating feature comprising an intersection of a first side and a second side wherein said intersection defines an angle of said penetrating region.

20. An apparatus according to claim 10, wherein said expansion feature comprises a collapsible opening defined in said fastening member, said collapsible opening extending from said first surface through said fastening member to and through said second surface.
